(19) United States
(12) Patent Application Publication
(10) Pub. No.: US 2006/0007246 A1
(43) Pub. Date: Jan. 12, 2006

(54) Method for displaying medical image information with viewing angle-dependent data sets superimpositions

(76) Inventors: Rudolf Ackermann, Buckenhof (DE); Holger Dresel, Altendorf (DE); Sultan Haider, Erlangen (DE); Rainer Kuth, Herzogenaurach (DE); Klaus Ludwig, Nurnberg (DE)

Correspondence Address: SCHIFF HARDIN, LLP;PATENT DEPARTMENT, 6600 SEARS TOWER, CHICAGO, IL, 60606-6473, US

(21) Appl. No.: 11/147,094

(22) Filed: Jun. 7, 2005

(30) Foreign Application Priority Data
Jun. 7, 2004 (DE) 10 2004 027 668.4

(51) Int. Cl. G09G 5/00

(52) U.S. Cl. 345/629; 345/656

(57) ABSTRACT

In a method for representation of medical image information on a display medium data sets from different medical examinations are supplied to various information channels of a 3D monitor. Various superimpositions of the data sets are displayed to an observer dependent on the viewing angle. The observer thus has simultaneous access to information from the various medical examinations, which makes the diagnosis easier for him or her.

### BACKGROUND OF THE INVENTION

1. Field of the Invention

The present invention concerns a method for representation of medical image information on a display medium, whereby the display medium is fashioned for display of different image information dependent on a viewing angle of an observer.

2. Description of the Prior Art

In medical diagnostics, a series of results of various examination methods frequently contributes to the generation of a diagnosis. These can be, for example, magnetic resonance examinations, computed tomography measurements or ultrasound examinations. To generate the diagnosis, an observer, for example a diagnosing physician, relies on a graphical representation of measured data sets on a display medium, for example a monitor. With known methods, only one data set can be shown on conventional monitors. In the event it is necessary to assess a number of data sets from various medical examinations, high demands are placed on the imagination capability of the observer, since frequently only a combination of information resulting from the data sets leads to a correct diagnosis.

Information from medical examinations can be shown three-dimensionally on 3D monitors. For example, a number of slices of a magnetic resonance examination can be shown as a three-dimensional image and thus make the diagnosis easier for the observer. In particular the depth information that can be shown by the 3D monitor is an important additional information source. A method and a device for generation of stereoscopic representations is described in German PS 42 28 111. Two-dimensional partial images are thereby provided at each opening position on a special monitor behind a special glass pane in which a number of sufficiently small openings sequentially cycle through the entire surface at high speed, such that an observer perceives a complete stereoscopic image. Various perspective views of an imaged subject (for example an examined human head) can be shown from different viewing angles. The use of such a monitor offers decisive advantages in the generation of a diagnosis, particularly in the case of medical examination methods in which a number of data sets can be combined into a three-dimensional image of a body region of a patient. However, with known representation methods it is also only possible to show data sets of an examination method on the 3D monitor. For generation of a diagnosis, the observer must furthermore keep track of a number of different data sets of different medical examinations that can at most be shown sequentially on the 3D monitor.

Furthermore, various methods are known to optimize the display and preparation of medical information towards special diagnostic applications. For visualization, it is known to generate so-called pseudo-3D representations that are displayed on a 2D monitor. The method of maximum projection (maximum intensity projection; in particular significant for angiography) is an example. In this method a maximum intensity value that of grey values encountered in a projection ray is selected and imaged in an observer image plane. In the maximum projection, an entire volume of a 3D data set is mapped and can be observed in any direction. Maximum projection is described in U.S. Pat. No. 5,566,282. A disadvantage of this known method is also that the diagnosing observer cannot simultaneously review the information from various diagnostic examinations.

### SUMMARY OF THE INVENTION

An object of the present invention is to provide a method for representation of medical image information that makes a diagnosis using data sets from various diagnostic examinations easier for the observer.

This object is achieved in accordance with the invention by a method wherein various superimpositions of at least two medical data sets are shown as image information at different viewing angles. The display medium is fashioned for display of different data sets dependent on a viewing angle of an observer. For example, it can be a 3D monitor of the type described above that displays different views of a three-dimensional subject in stereoscopic representation at different viewing angles. This possibility of the 3D monitor is used by the method to supply different superimpositions of data sets, in particular of various medical examination methods, to the various information channels of the monitor, such that the observer sees different superimpositions of the data sets from different viewing angles. For example, data sets can be displayed from magnetic resonance T1 contrast, magnetic resonance T2 contrast, magnetic resonance phosphor signal, ultrasound at low frequency, ultrasound at high frequency, computer tomography at low acceleration voltage or computer tomography at high acceleration voltage. The observer thus has the possibility to simultaneously have displayed a number of superimposed data sets and to vary the superimposition via variation of his or her viewing angle. In the observation, depth information is imparted to the viewer (unlike known methods for representation of three-dimensional images) since the corresponding information channel of the display medium is used for generation of the superimposition.

In an embodiment, each of the superimpositions is generated by simultaneous display of the data sets, with each of the data sets being weighted with a weighting factor. This is a simple method for generation of the superimpositions.

In another embodiment of the method, the display medium is fashioned to detect a position of the observer. By detection of the position of the observer, at least one image representation parameter is changed dependent on this position. Thus can be, for example, the brightness of the displayed image information. This has the advantage that the observer can change the image representation parameter in a simple manner and thus adapt the directly viewed representation to his or her desires.

In a further embodiment, at least one of the data sets is generated from a number of partial data sets by maximum projection. This known method of display of data sets is here combined with the inventive method in an advantageous manner. The maximum projection, for example, can ensue separately before the generation of the superimposition for each of the data sets to be displayed. In the case of two data sets to be superimposed, two views, that are then displayed superimposed, are created from a number of partial data sets. This is frequently advantageous for the generation of a diagnosis.

In a further embodiment a parameterized volume rendering technique is used for generation of at least one of the data sets. The different tissue classes are thereby allocated with various surfaces such that they appear in a pseudo-3D representation can clearly be differentiated from one another.

### DESCRIPTION OF THE DRAWINGS

FIG. 1 is a flowchart of the invention method.

FIG. 2 schematically illustrates an apparatus for implementing the inventive method.

### DESCRIPTION OF THE PREFERRED EMBODIMENTS

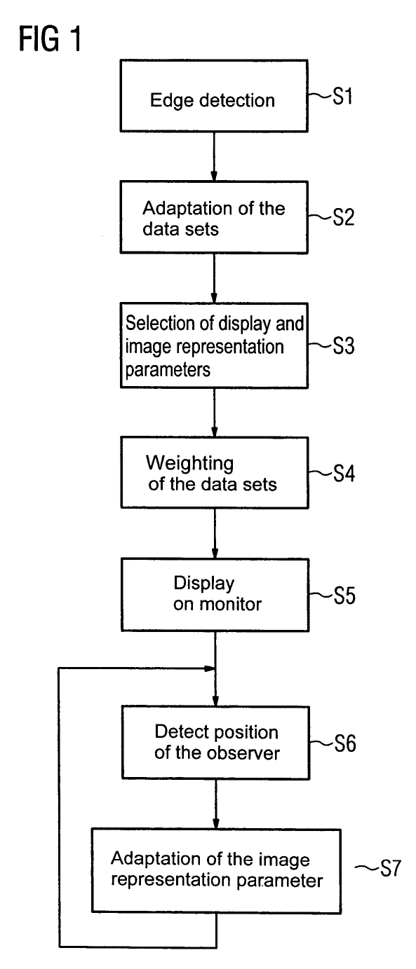

FIG. 1 shows the preparation and representation of the various data sets in accordance with the invention, in a flowchart. Initially, in a first method step S1 an edge detection is implemented on each data set. The edge detection is used in a second method step S2 for adaptation of the data sets to one another. This is necessary since the data sets of the different medical examinations do not necessarily exactly contain an identical part of a respective examination subject. For example, in the edge detection a boundary between muscle and bone tissue can be identified as an edge that is then brought into congruence on all data sets to be considered. In a third step S3, the user selects the desired type of the representation and an image representation parameter. This can be, for example, maximum projection, partially transparent representation of surfaces, or parameterized volume rendering technique representation. After this, in a fourth method step S4 the weighting of the data sets ensues for the different viewing angles, which are stored in the information channels of the 3D monitor in a further method step S5. If, for example, two magnetic resonance data sets are to be displayed, of which one was acquired with T1 weighting and the other was acquired with T2 weighting, the display is selected such that the observer sees only the T1-weighted data set at a viewing angle of 45° to the right of the screen normal. Correspondingly, only the T2-weighted data set is displayed for the viewing angle 45° to the left of the screen normal. For each viewing angle in-between, both data sets are displayed superimposed, having been previously multiplied with weighting factors. Given a perpendicular observation of the screen, both data sets are thus shown multiplied with the weighting factor of 0.5. Given a viewing angle of, for example, 30° to the right of the screen normal, the T1-weighted data set is weighted with 0.75, the T2-weighted data set is weighted with 0.25. Via the weighted superimposition of both images, the doctor has an immediate access to both sets of information, so the diagnosis is made easier for him or her. By the use of a 3D monitor, for example of the previously described type, the simultaneous representation of all superimpositions is possible without determination of the actual viewing angle of the observer. Thus it has the advantage that a number of observers can simultaneously use the screen.

Additionally, each data set is modified corresponding to the selected representation before the display. The data sets that are composed of a number of partial data sets of a part of the patient are thus mapped, for example by means of maximum projection. The advantages of the representation by maximum projection can consequently also be used in the weighted superimposition. A pseudo-3D impression that is also maintained in the superimposition is thus imparted to the observer.

After this, in step S6 the position of the observer is detected and the likewise selected image representation parameter is adapted to the position in a last step S7. Both of the last steps are continuously executed in a loop during the display of the image.

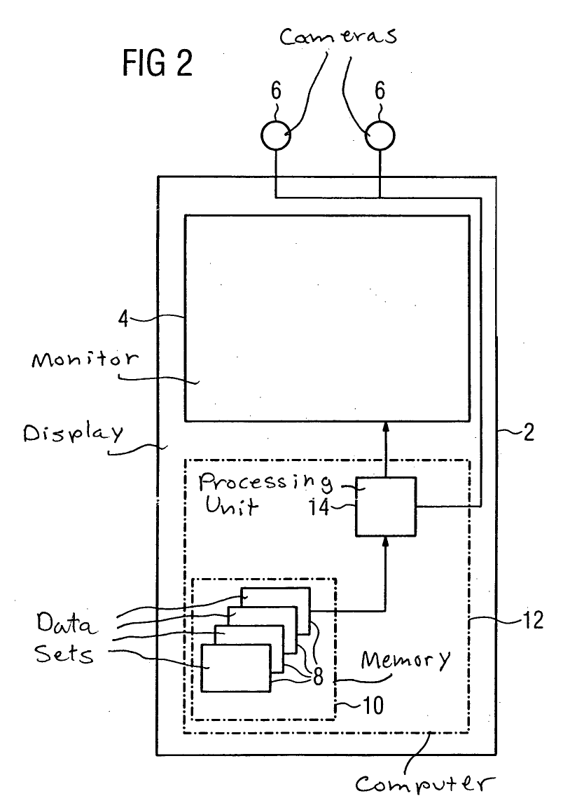

FIG. 2 shows a display 2 with a 3D monitor 4 and two cameras 6 for detection of the position of the observer. The data sets 8 are stored, for example, in a memory 10 of a computer 12. They are superimposed by a processing unit 14 and shown on the 3D monitor 4. The superimposition is different for each viewing angle, such that the observer sees a different representation of the data sets 9 by changing his viewing angle. The 3D monitor is fashioned such that all possible viewing angles are shown simultaneously, such that a number of observers can simultaneously observe from different viewing angles. The position of one of the observers is continuously detected by the two cameras 6 and the image representation parameter is correspondingly changed by the processing unit 14. Thus the observer can change, for example, the brightness of the shown image by changing his or her distance from the 3D monitor 4.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for displaying medical image information comprising the steps of:
displaying medical information comprising at least two superimposed medical data sets in a presentation on a display medium that allows different information to be displayed dependent on a viewing angle of an observer; and
in said presentation, causing different superimpositions of said at least two medical data sets to be visible at said display at respectively different viewing angles.

2. A method as claimed in claim 1 comprising creating the respective superimpositions by simultaneously displaying medical data sets comprising the superimposition with the respective medical data sets comprising the superimposition being weighted with respective weighting factors.

3. A method as claimed in claim 1 comprising:
detecting a position of said observer; and
changing at least one image representation parameter, that alters display of at least one of said superimpositions, dependent on the position of the observer.

4. A method as claimed in claim 1 comprising generating at least one of said data sets from a plurality of partial data sets by maximum projection.

5. A method as claimed in claim 1 comprising generating at least one of said medical data sets from a plurality of partial data sets by partially transparent representation of surfaces.

6. A method as claimed in claim 1 comprising generating at least one of said medical data sets from a plurality of partial data sets by a parameterized volume rendering technique.

7. A method as claimed in claim 1 comprising detecting edges of said medical data sets with an edge detection algorithm.

8. A method as claimed in claim 9 comprising adapting the respective medical data sets to each other at said display dependent on the detected edges.
